(19) United States
(12) Patent Application Publication
(10) Pub. No.: US 2026/0237149 A1
(43) Pub. Date: Aug. 13, 2026

(54) INFORMATION PROCESSING DEVICE, INFORMATION PROCESSING METHOD, AND STORAGE MEDIUM

(71) Applicant: Sony Group Corporation, Tokyo (JP)

(72) Inventor: Takeshi MIYAI, Kanagawa (JP)

(73) Assignee: Sony Group Corporation, Tokyo (JP)

(21) Appl. No.: 19/153,361

(22) PCT Filed: Feb. 20, 2024
(86) PCT No.: PCT/JP2024/005923

§ 371 Date: Aug. 4, 2025

(30) Foreign Application Priority Data
Mar. 9, 2023 (JP) 2023-036472

(51) Int. Cl. G06T 15/20; G06T 3/4053; G06T 5/70; G06T 7/80

(52) U.S. Cl. CPC G06T 15/205; G06T 3/4053; G06T 5/70; G06T 7/80; G06T 2207/10016; G06T 2207/20016; G06T 2210/36

(57) ABSTRACT

An information processing device in the present technology includes a rendering unit that renders, on the basis of filming information regarding filming by a camera that films a display installed in a real space, a two-dimensional area within an angle of view of the camera indicating a predetermined three-dimensional space corresponding to the angle of view with reference to a display surface of the display, and an image quality adjustment unit that reduces image quality of the area within the angle of view rendered by the rendering unit in a case where an amount of blur on the display surface in a filmed video filmed by the camera increases. The present technology can be applied to, for example, a filming system used for virtual production in which a subject is filmed with a video displayed on a display as a background.

### TECHNICAL FIELD

The present technology relates to an information processing device, an information processing method, and a storage medium, and more particularly to an information processing device, an information processing method, and a storage medium capable of reducing the amount of calculation for rendering.

### BACKGROUND ART

In recent years, virtual production (in-camera VFX), which is a filming technique that uses large displays, has been gaining popularity in movie and TV production.

In virtual production, filming is performed with a video displayed on a display as a background and a subject arranged in front of the display as a foreground. The display shows, for example, a computer graphics (CG) video that appears as the background when the subject is filmed from a specific camera position within a three-dimensional space. The CG video is rendered on the basis of a position and an angle of view of the camera (see, for example, Patent Document 1).

### CITATION LIST

### Patent Document

Patent Document 1: U.S. Patent Application Publication No. 2021/0183138

### SUMMARY OF THE INVENTION

### Problems to be Solved by the Invention

In virtual production, filming is often done with a moving camera, so it is necessary to continuously obtain filming information indicating a position and an angle of view of the camera, and render a CG video in real time for display on a screen on the basis of the filming information.

It is preferable to use a display having a large screen and a high resolution so that the CG video remains as a background even when the camera is moved or filming is done with a wide angle of view. In order to render a CG video displayed on the display having a large screen and a high resolution, a large amount of calculation is required, and there is a possibility that the CG video cannot be displayed in real time.

The present technology has been made in view of such circumstances, and makes it possible to reduce the amount of calculation for rendering.

### Solutions to Problems

An information processing device according to an aspect of the present technology includes a rendering unit that renders, on the basis of filming information regarding filming by a camera that films a display installed in a real space, a two-dimensional area within an angle of view of the camera indicating a predetermined three-dimensional space corresponding to the angle of view with reference to a display surface of the display, and an image quality adjustment unit that reduces image quality of the area within the angle of view rendered by the rendering unit in a case where an amount of blur on the display surface in a filmed video filmed by the camera increases.

An information processing method according to an aspect of the present technology includes by an information processing device, rendering, on the basis of filming information regarding filming by a camera that films a display installed in a real space, a two-dimensional area within an angle of view of the camera indicating a predetermined three-dimensional space corresponding to the angle of view with reference to a display surface of the display, and reducing image quality of the area within the angle of view rendered in a case where an amount of blur on the display surface in a filmed video filmed by the camera increases.

A storage medium according to an aspect of the present technology stores a program for achieving a process including rendering, on the basis of filming information regarding filming by a camera that films a display installed in a real space, a two-dimensional area within an angle of view of the camera indicating a predetermined three-dimensional space corresponding to the angle of view with reference to a display surface of the display, and reducing image quality of the area within the angle of view rendered by the rendering unit in a case where an amount of blur on the display surface in a filmed video filmed by the camera increases.

In an aspect of the present technology, a two-dimensional area within an angle of view of a camera indicating a three-dimensional space corresponding to the angle of view with reference to a display surface of a display installed in a real space is rendered on the basis of filming information regarding filming by the camera that films the display, and image quality of the area within the angle of view rendered is reduced in a case where an amount of blur on the display surface in a filmed video filmed by the camera increases.

### BRIEF DESCRIPTION OF DRAWINGS

FIG. 1 is a diagram illustrating an outline of a filming system to which the present technology is applied.

FIG. 2 is a diagram illustrating an example of a filmed video filmed by a camera.

FIG. 3 is a diagram illustrating an example of a state of filming.

FIG. 4 is a block diagram illustrating an example of configuration of the filming system.

FIG. 5 is a block diagram illustrating an example of functional configuration of an information processing device.

FIG. 6 is a flowchart illustrating a process performed by the information processing device having the configuration of FIG. 5.

FIG. 7 is a diagram illustrating an example of the amount of blur on an approximate display surface.

FIG. 8 is a diagram illustrating an example of comparison between a pixel interval of a display and the amount of blur on the approximate display surface.

FIG. 9 is a block diagram illustrating an example of functional configuration of an information processing device that enlarges a reduced CG video by super-resolution processing.

FIG. 10 is a flowchart illustrating a process performed by the information processing device having the configuration of FIG. 9.

FIG. 11 is a block diagram illustrating an example of hardware configuration of a computer.

### MODE FOR CARRYING OUT THE INVENTION

Modes for carrying out the present technology will be described hereinafter. The description will be given in the following order.
1. Outline of Filming System
2. Configuration and Operation of Filming System
3. Modifications

### 1. Outline of Filming System

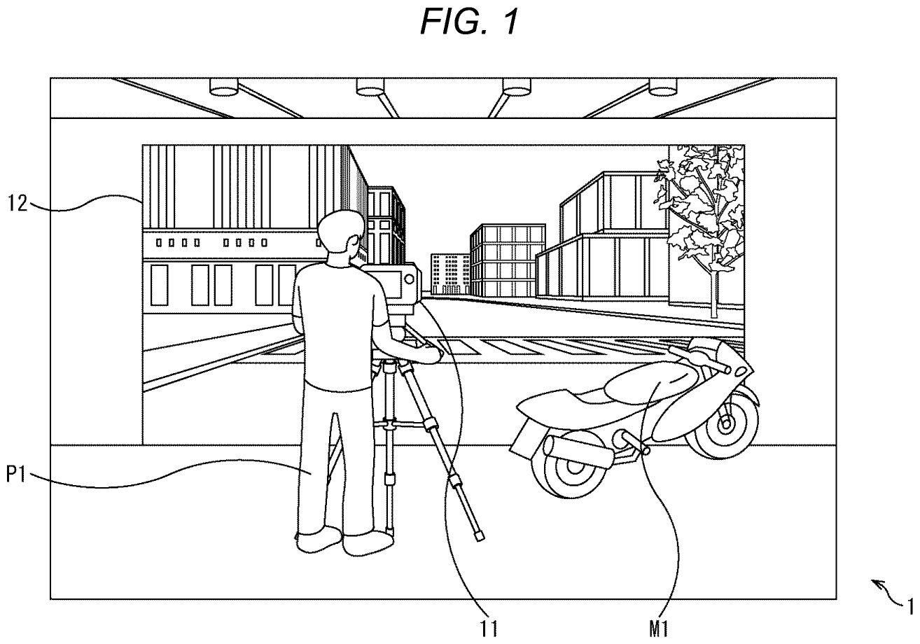

FIG. 1 is a diagram illustrating an outline of a filming system 1 to which the present technology is applied.

The filming system 1 in FIG. 1 is a system used for filming by, for example, virtual production (in-camera VFX). The filming system 1 includes a camera 11, a video storage device (not illustrated) that stores a filmed video filmed by the camera 11, a wall-type display 12, and an information processing device (not illustrated) that controls the display 12.

The display 12 includes, for example, a light emitting diode (LED) display, and is arranged in a real space such as a studio. The display 12 displays, for example, a computer graphics (CG) video that is a video of a three-dimensional space created by CG. A camera operator P1 uses the camera 11 to capture an image of a motorcycle M1, which is a subject, with the CG video displayed on the display 12 as a background.

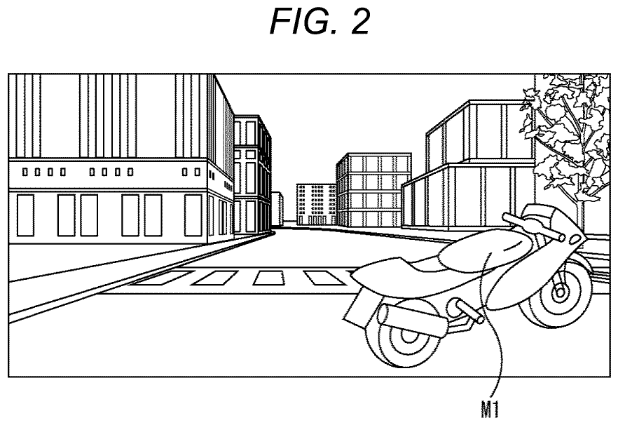

FIG. 2 is a diagram illustrating an example of a filmed video filmed by the camera 11.

As illustrated in FIG. 2, the filmed video filmed by the camera 11 looks as if the motorcycle M1 exists in the three-dimensional space shown in the CG video. The camera operator P1 can thus film, in the studio, a video in which a space appearing in the CG video spreads in the background of the motorcycle M1 by performing filming using the filming system 1.

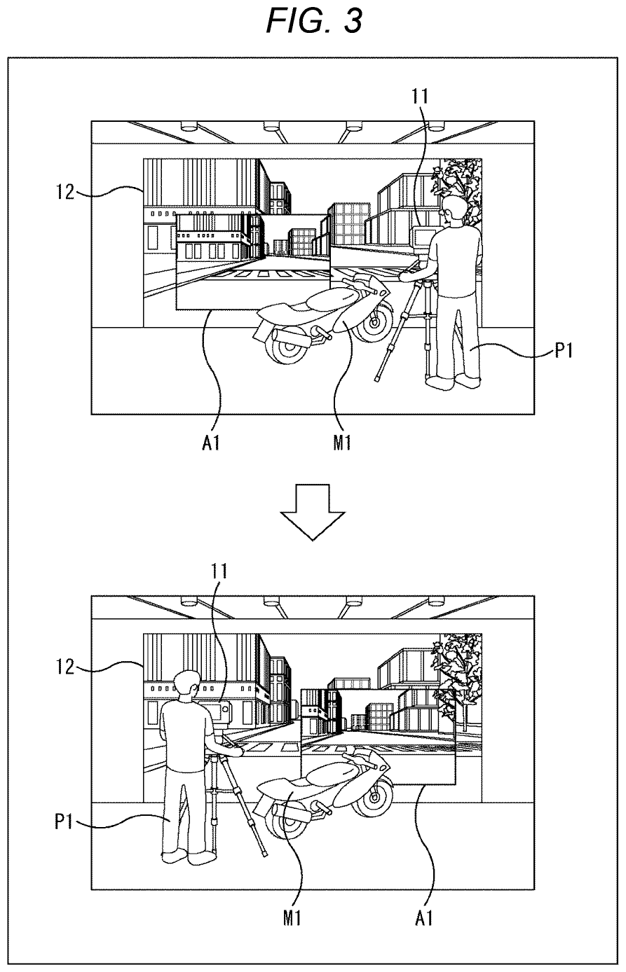

FIG. 3 is a diagram illustrating an example of a state of filming.

As illustrated in FIG. 3, for example, the entirety of the CG video is displayed all over the display 12 during the filming.

As illustrated on an upper side of FIG. 3, in a case where the camera 11 performs filming from a right side of the motorcycle M1 disposed at the center, a part of the CG image is displayed, in a filming area A1, which is an area on the display 12 included in an angle-of-view range of the camera 11, in such a way as to be superimposed on the entirety of the CG image. In the filming area A1, for example, a video in a portion of the three-dimensional space shown in the CG image that becomes the background when filming is performed from the right side of the motorcycle M1 is cut out from the entirety of the CG video and displayed.

As illustrated on a lower side of FIG. 3, in a case where the camera 11 performs filming from a left side of the motorcycle M1 disposed at the center, a part of the CG video is displayed in a filming area A1 in such a way as to be superimposed on the entirety of the CG image. In the filming area A1, for example, a video in a portion of the three-dimensional space shown in the CG image that becomes the background when filming is performed from the left side of the motorcycle M1 is cut out from the entirety of the CG video and displayed.

In this manner, at the time of filming, the camera operator P1 performs filming while sequentially changing a position, the angle of view, a focus position, an aperture value, and the like of the camera 11.

The information processing device tracks the camerawork (position and angle of view) of the camera 11, and controls the position on the display 12 where the CG video is displayed according to the camerawork of the camera 11. Specifically, the information processing device detects the filming area on the basis of the position, a posture, setting, and the like of the camera 11, and controls the CG video displayed in the filming area. A portion of the CG video displayed in the filming area will be referred to as an inner frustum (an area within the angle of view) hereinafter.

Note that although the filming area A1 is surrounded by a thick line in FIG. 3 for easy understanding of the description, the line surrounding the filming area is not actually displayed.

In virtual production, filming is often done with a moving camera, so it is necessary to continuously obtain filming information indicating a position and an angle of view of the camera, and render a CG video in real time for display on a screen on the basis of the filming information.

It is preferable to use a display having a large screen and a high resolution so that the CG video remains as a background even when the camera is moved or filming is done with a wide angle of view. In order to render a CG video displayed on the display having a large screen and a high resolution, a large amount of calculation is required, and there is a possibility that the CG video cannot be displayed in real time.

Conventionally, in order to achieve real-time display of a CG video, it has been proposed to reduce the amount of calculation per computer by dividing a display into a plurality of areas and rendering a CG video displayed in each area by a different computer.

Introducing a computer system including a plurality of computers, however, requires a very large amount of cost.

The amount of calculation for rendering increases in a case where the number of objects appearing in the CG video is increased, the objects are complicatedly expressed, or reflection of light is strictly reproduced in order to make the objects appear more realistic. Therefore, in order to achieve real-time display of a CG video, it has been conventionally proposed to simplify the number, complexity, representation of light, and the like of objects appearing in the CG video.

If the number, complexity, representation of light, and the like of objects appearing in a CG video are simplified, however, quality of the CG video may deteriorate, and a demand of a producer of a movie or a drama may not be satisfied.

It is sufficient that an outer frustum (an area outside the angle of view), which is a CG video other than the inner frustum, can be used as a part of reflection on a reflecting surface or illumination. It is also possible to reduce the amount of calculation for rendering by rendering only the inner frustum with high quality and in real time and rendering the outer frustrum with reduced quality and frame rate.

In a case where the entirety of the display 12 is filmed by moving the camera 11 away from the display 12 or widening the angle of view, however, the CG video displayed all over the large-screen and high-resolution display 12 is rendered in real time, and the amount of calculation for rendering cannot be reduced.

An embodiment of the present technology has been conceived by focusing on the above points, and proposes a technique capable of reducing the amount of calculation for rendering without causing an increase in cost or deterioration in quality of a CG video even in a case where the entirety of the display 12 is filmed. The present embodiment will be described hereinafter in detail.

### 2. Configuration and Operation of Filming System

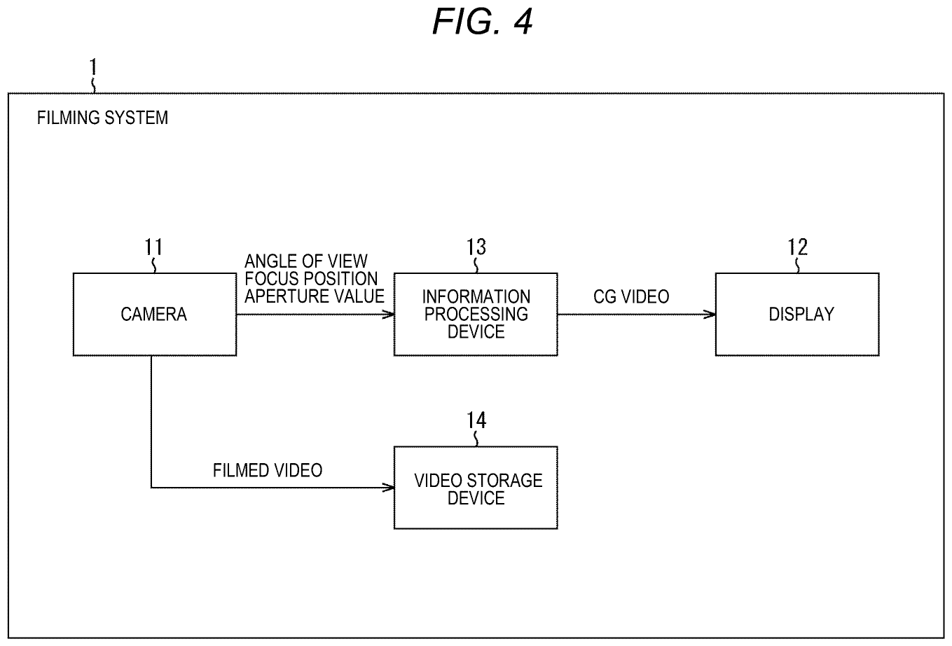

FIG. 4 is a block diagram illustrating an example of configuration of the filming system 1.

As illustrated in FIG. 4, the filming system 1 includes the camera 11, the display 12, an information processing device 13, and a video storage device 14.

The camera 11 supplies, to the video storage device 14, a filmed video obtained by filming a subject with a CG video displayed on the display 12 as a background. The camera 11 sequentially supplies information indicating an internal state, such as the angle of view, the focus position, and the aperture value, to the information processing device 13.

The information processing device 13 is a device that controls the display 12. The information processing device 13 sequentially estimates a relative position of the camera 11 with respect to the display 12. The information processing device 13 creates a CG video on the basis of the relative position and the internal state of the camera 11. Resolution of a created CG video is equal to that of the display 12. The information processing device 13 causes the display 12 to display the created CG video.

Note that an example will be described hereinafter in which not only the inner frustum is rendered in real time, but a CG video displayed all over the display 12 is rendered in real time.

The display 12 displays a CG video under the control of the information processing device 13.

The video storage device 14 stores filmed videos supplied from the camera 11.

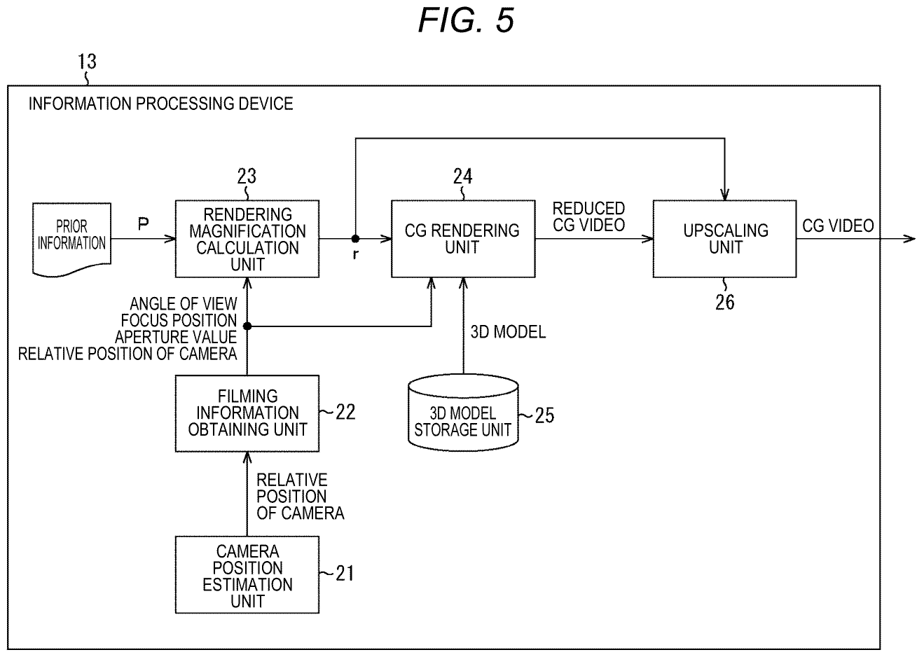

FIG. 5 is a block diagram illustrating an example of functional configuration of the information processing device 13.

As illustrated in FIG. 5, a camera position estimation unit 21, a filming information obtaining unit 22, a rendering magnification calculation unit 23, a CG rendering unit 24, a 3D model storage unit 25, and an upscaling unit 26 are included.

The camera position estimation unit 21 estimates the relative position of the camera 11 with respect to the display 12. The relative position of the camera 11 is estimated, for example, on the basis of a result of tracking using an infrared (IR) camera provided in a studio and a marker including a retroreflective material.

The filming information obtaining unit 22 obtains filming information that is information regarding filming by the camera 11. Specifically, the filming information obtaining unit 22 obtains information indicating the internal state of the camera 11 from the camera 11 as the filming information, and obtains information indicating the relative position of the camera 11 from the camera position estimation unit 21. The filming information obtaining unit 22 supplies the filming information to the rendering magnification calculation unit 23 and the CG rendering unit 24.

The rendering magnification calculation unit 23 obtains information indicating a pixel interval P of the display 12 as prior information that does not change during filming. The rendering magnification calculation unit 23 calculates a rendering magnification r indicating a ratio of the resolution of a CG video to the resolution of the display 12 on the basis of the filming information supplied from the filming information obtaining unit 22 and the pixel interval P of the display 12. Details of a method for calculating the rendering magnification r will be described later. The rendering magnification r is a value of 1 or less. The rendering magnification calculation unit 23 supplies information indicating the calculated rendering magnification r to the CG rendering unit 24 and the upscaling unit 26.

The rendering magnification calculation unit 23 functions as an image quality adjustment unit that adjusts image quality of a CG video rendered by the CG rendering unit 24.

The CG rendering unit 24 obtains a 3D model indicating 3D information regarding the background from the 3D model storage unit 25, and arranges the 3D model in a three-dimensional space. A virtual display 12 is arranged in the three-dimensional space. The CG rendering unit 24 arranges the virtual camera 11 in the three-dimensional space on the basis of the filming information supplied from the filming information obtaining unit 22, and projects the 3D model viewed from the virtual camera 11 on a display surface of the virtual display 12 to render the CG video.

The CG rendering unit 24 renders a CG video having a resolution obtained by multiplying the resolution of the display 12 by the rendering magnification r. Since the rendering magnification r is a value of 1 or less, the resolution of the CG video to be rendered is a value equal to or less than the resolution of the display 12.

A CG video having a resolution equal to or lower than the resolution of the display 12 will be referred to as a reduced CG video hereinafter.

The CG rendering unit 24 supplies the rendered reduced CG video to the upscaling unit 26.

The 3D model storage unit 25 stores 3D models to be arranged in a three-dimensional space.

The upscaling unit 26 creates a CG video having a resolution equal to the resolution of the display 12 by enlarging the reduced CG video supplied from the CG rendering unit 24 to an inverse multiple (1/r times) of the rendering magnification r calculated by the rendering magnification calculation unit 23. The processing for enlarging the reduced CG video is performed using a method such as bicubic interpolation or Lanczos interpolation.

The upscaling unit 26 functions as a display control unit that supplies the created CG video to the display 12 to display the CG video.

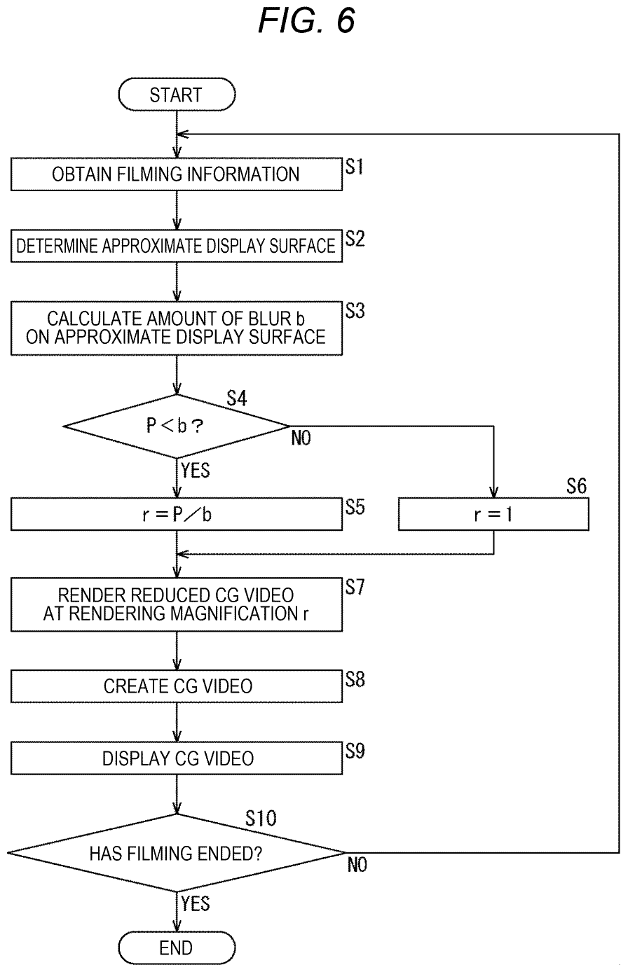

Next, a process performed by the information processing device 13 having the above-described configuration will be described with reference to a flowchart of FIG. 6. For example, when the camera 11 starts filming, the process of FIG. 6 is started. The rendering magnification calculation unit 23 obtains the pixel interval P of the display 12, for example, before the filming is started.

In step S1, the filming information obtaining unit 22 obtains filming information from the camera 11 and the camera position estimation unit 21.

In step S2, the rendering magnification calculation unit 23 determines an approximate display surface on the basis of the filming information.

In step S3, the rendering magnification calculation unit 23 calculates an amount of blur b on the approximate display surface in a filmed video on the basis of the filming information.

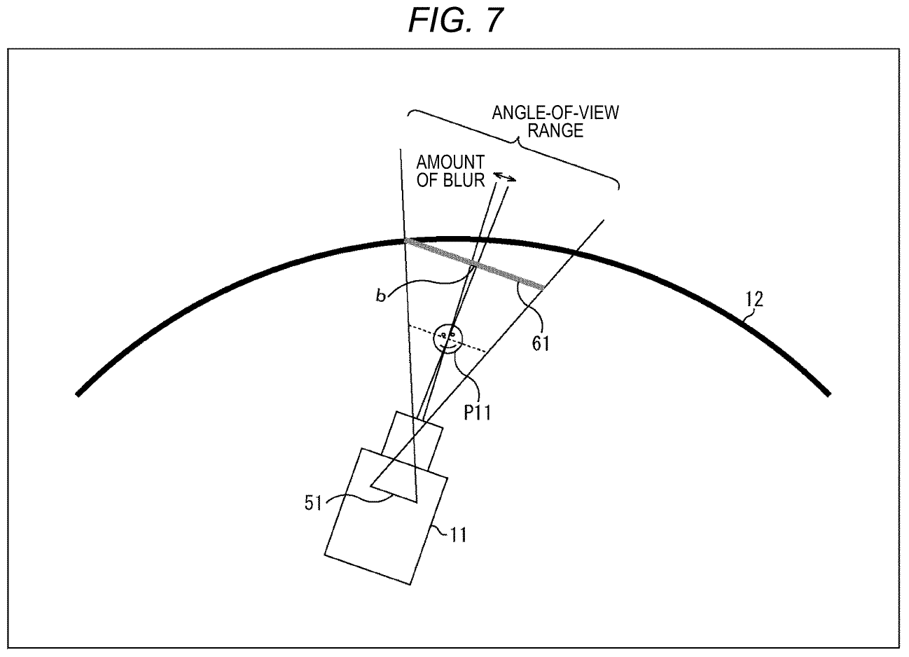

FIG. 7 is a diagram illustrating an example of the amount of blur b on the approximate display surface. In FIG. 7, an example in which the display surface of the display 12 is formed in such a way as to be curved in an arc shape will be described. Note that the display surface of the display 12 may have another shape such as a flat plate shape.

The rendering magnification calculation unit 23 can estimate, on the basis of the relative position and the angle of view of the camera 11, a positional relationship between the display 12 and an angle-of-view range, which is a range of filming by an image sensor 51 mounted on the camera 11. The rendering magnification calculation unit 23 determines, as the approximate display surface, a plane including at least one point where the angle-of-view range intersects with the display 12 and facing the camera 11. In the example of FIG. 7, a plane including a point nearest to the camera 11 among points where the angle-of-view range and the display 12 intersect and facing the camera 11 is determined as an approximate display surface 61.

The rendering magnification calculation unit 23 can calculate the amount of blur generated in a filmed image in accordance with a distance from the camera 11 on the basis of the focus position and the aperture value of the camera 11. The rendering magnification calculation unit 23 calculates the amount of blur b corresponding to the distance from the camera 11 to the approximate display surface 61 as the amount of blur b on the approximate display surface 61 in the filmed video.

In the filming by virtual production, a focus of the camera 11 is basically adjusted to a person P11 as a subject. It is considered that the display 12 serving as the background is not in focus, and a video in which an area including the display 12 is blurred is filmed.

Since the display 12 appears blurred in the filmed video, there is no difference between a filmed video filmed while an originally blurred CG video is displayed on the display 12 and a filmed video filmed while a non-blurred CG video is displayed on the display 12. In other words, even if a pattern finer than the amount of blur b on the approximate display surface 61 is expressed by a CG video, the pattern is blurred because the focus is not adjusted, and the camera 11 cannot film the pattern.

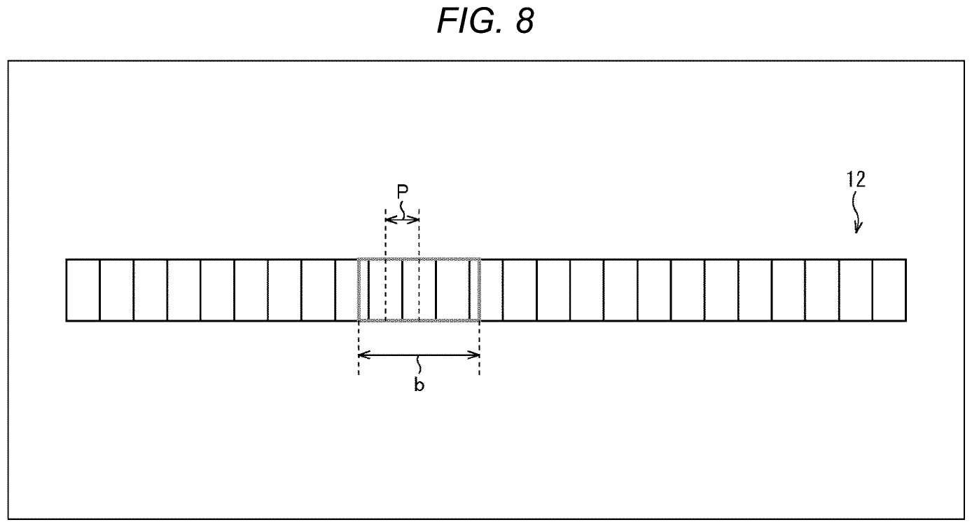

Therefore, as illustrated in FIG. 8, in a case where the pixel interval P (a distance between adjacent pixel centers) of the display 12 is smaller than the amount of blur b on the approximate display surface 61, it is sufficient to render a CG video having the amount of blur b as the pixel interval.

Returning to FIG. 6, in step S4, the rendering magnification calculation unit 23 determines whether or not the pixel interval P of the display 12 is less than the amount of blur b on the approximate display surface.

If it is determined in step S4 that the pixel interval P of the display 12 is less than the amount of blur b on the approximate display surface, the process proceeds to step S5. In step S5, the rendering magnification calculation unit 23 calculates the rendering magnification r by dividing the pixel interval P of the display 12 by the amount of blur b on the approximate display surface (r=P/b). Since P<b, r<1.

If it is determined in step S4 that the pixel interval P of the display 12 is equal to or more than the amount of blur b on the approximate display surface, on the other hand, the process proceeds to step S6. In step S6, the rendering magnification calculation unit 23 sets a value of the rendering magnification r to 1 (r=1).

After the rendering magnification r is calculated in step S5 or step S6, the process proceeds to step S7. In step S7, the CG rendering unit 24 renders the reduced CG video at the rendering magnification r.

In step S8, the upscaling unit 26 creates a CG video having a resolution equal to the resolution of the display 12 by enlarging the reduced CG video. If r<1, the reduced CG video having a resolution lower than the resolution of the display 12 is enlarged, and a blurred CG video is created.

In step S9, the upscaling unit 26 causes the display 12 to display the CG video.

In step S10, the information processing device 13 determines whether or not the filming has ended.

If it is determined in step S10 that the filming has not ended, the process returns to step S1, and the subsequent processing is repeated. If it is determined in step S10 that the filming has ended, on the other hand, the process ends.

As described above, in the information processing device 13 according to the present technology, a two-dimensional CG video (inner frustum) indicating a predetermined three-dimensional space corresponding to the angle of view of the camera 11 with reference to the display surface of the display 12 is rendered on the basis of the filming information regarding filming by the camera 11 that films the display 12 installed in the real space, and in a case where the amount of blur on the display surface of the display 12 in the filmed video filmed by the camera 11 increases, image quality of the CG video rendered by the CG rendering unit 24 decreases.

Degradation of the image quality of the CG video is achieved, for example, by setting a resolution (first resolution) of the CG video rendered by the CG rendering unit 24 to be lower than a resolution (second resolution) of the display 12.

The rendering magnification r indicating a ratio of the first resolution to the second resolution is calculated on the basis of the pixel interval P of the display 12 and the amount of blur b on the display surface (approximate display surface) of the display 12, and is calculated, for example, at a ratio of P/b or more at which no difference occurs in the filmed video. By reducing the resolution of the CG video rendered by the CG rendering unit 24 within a range in which there is no difference in the filmed video, the amount of calculation for rendering can be reduced.

Therefore, the amount of calculation for rendering can be reduced without degrading the quality of the CG video shown in the filmed video. By reducing the amount of calculation for rendering, it is possible to use, as a background, a complex CG that has been difficult to display in real time. In addition, it is possible to achieve filming by virtual production using a low-cost computer having low calculation capability.

### 3. Modifications

### ⋅Example of Performing Super-Resolution Processing

The processing for enlarging a reduced CG video may be performed using an advanced method such as a super-resolution technique instead of a general interpolation method.

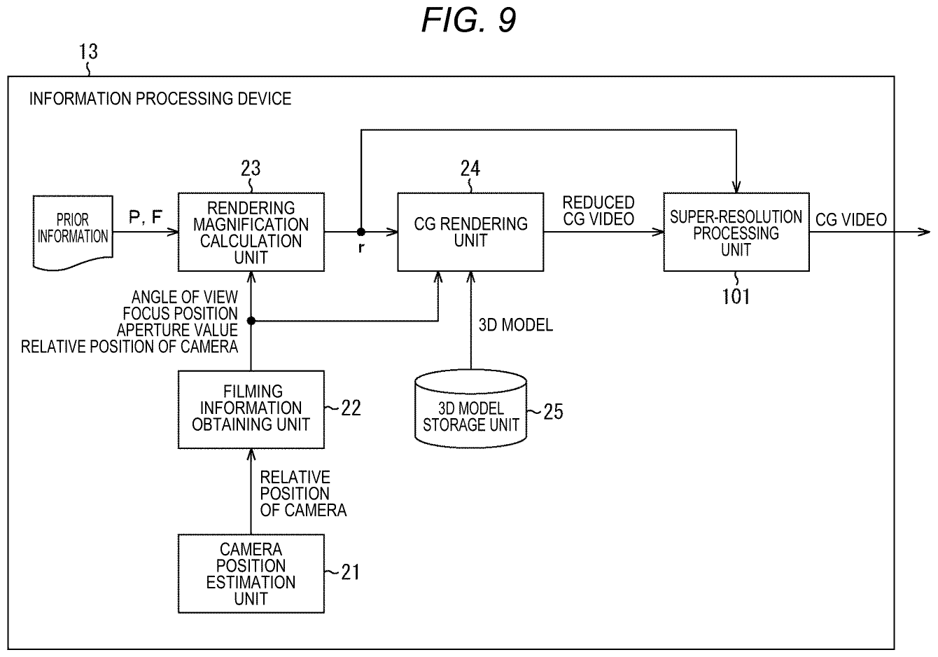

FIG. 9 is a block diagram illustrating an example of functional configuration of an information processing device 13 that enlarges a reduced CG video by super-resolution processing. In FIG. 9, the same components as those in FIG. 5 are denoted by the same reference signs. Redundant description is omitted as appropriate.

The information processing device 13 in FIG. 9 is different from the information processing device 13 in FIG. 5 in that a restoration magnification F is obtained by the rendering magnification calculation unit 23 as prior information and that a super-resolution processing unit 101 is provided instead of the upscaling unit 26.

In the super-resolution processing, at a magnification within a certain range, by enlarging the reduced CG video, it is possible to generate a CG video (CG video without blur) equivalent to a CG video rendered at a resolution equal to a resolution after the enlargement. Generating a CG video equivalent to a CG video rendered at a resolution equal to a resolution after enlargement will be referred to as image quality restoration by super-resolution processing.

The restoration magnification F indicates the maximum magnification at which image quality can be restored by the super-resolution processing. The restoration magnification F is a value of 1 or more, and is a known magnification determined by performance of the super-resolution processing.

The rendering magnification calculation unit 23 calculates the rendering magnification r on the basis of the filming information, the pixel interval P of the display 12, and the restoration magnification F. Details of a method for calculating the rendering magnification r will be described later. The rendering magnification calculation unit 23 supplies information indicating the calculated rendering magnification r to the CG rendering unit 24 and the super-resolution processing unit 101.

The super-resolution processing unit 101 creates a CG video having a resolution equal to the resolution of the display 12 by enlarging, by the super-resolution processing, the reduced CG video supplied from the CG rendering unit 24 to an inverse multiple (1/r times) of the rendering magnification r calculated by the rendering magnification calculation unit 23.

The super-resolution processing unit 101 functions as a display control unit that supplies a created CG video to the display 12 to display the CG video.

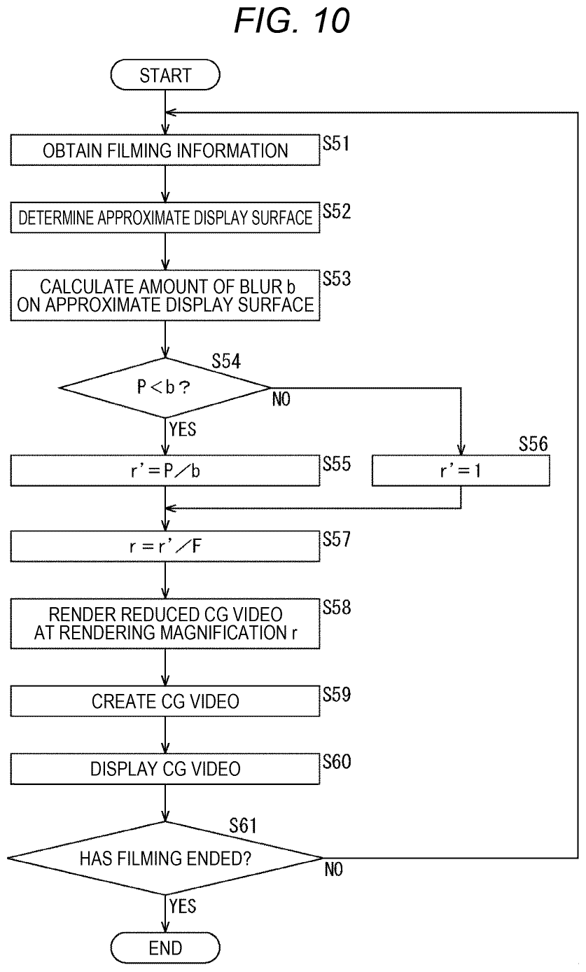

Next, a process performed by the information processing device 13 having the configuration of FIG. 9 will be described with reference to a flowchart of FIG. 10. For example, when the camera 11 starts filming, the process of FIG. 10 is started. The rendering magnification calculation unit 23 obtains the pixel interval P of the display 12 and the restoration magnification F, for example, before the filming is started.

In steps S51 to S53, processing similar to that in steps S1 to S3 of FIG. 6 is performed.

In step S54, the rendering magnification calculation unit 23 determines whether or not the pixel interval P of the display 12 is less than the amount of blur b on the approximate display surface.

If it is determined in step S54 that the pixel interval P of the display 12 is less than the amount of blur b on the approximate display surface, the process proceeds to step S55. In step S55, the rendering magnification calculation unit 23 calculates a temporary rendering magnification r′ by dividing the pixel interval P of the display 12 by the amount of blur b on the approximate display surface (r′=P/b).

If it is determined in step S54 that the pixel interval P of the display 12 is equal to or more than the amount of blur b on the approximate display surface, on the other hand, the process proceeds to step S56. In step S56, the rendering magnification calculation unit 23 sets a value of the temporary rendering magnification r to 1 (r′=1).

After the temporary rendering magnification r′ is calculated in step S55 or step S56, the process proceeds to step S57. In step S57, the temporary rendering magnification r′ is divided by the restoration magnification F to calculate the rendering magnification r (r=r′/F).

In step S58, the CG rendering unit 24 renders the reduced CG video at the rendering magnification r.

In step S59, the super-resolution processing unit 101 creates a CG video having a resolution equal to the resolution of the display 12 by enlarging the reduced CG video by the super-resolution processing. Since the image quality can be restored even if the enlargement processing is performed at the restoration magnification F, the CG video generated by the super-resolution processing becomes the CG video equivalent to a CG video obtained by enlarging a reduced CG video rendered at the temporary rendering magnification r′ to an inverse multiple of the temporary rendering magnification r′. If r′<1, a blurred CG video is created.

In step S60, the super-resolution processing unit 101 causes the display 12 to display the CG video.

In step S61, the information processing device 13 determines whether or not the filming has ended.

If it is determined in step S61 that the filming has not ended, the process returns to step S51, and the subsequent processing is repeated. If it is determined in step S61 that the filming has ended, on the other hand, the process ends.

As described above, in the super-resolution processing, since the image quality can be restored even if the enlargement processing is performed at the restoration magnification F, the information processing device 13 of the present technology can restore a reduced CG video rendered at an original resolution by the super-resolution processing even if a reduced CG video is rendered at a resolution obtained by dividing the original resolution by the restoration magnification F.

The rendering magnification r is calculated on the basis of the restoration magnitude F along with the pixel interval P of the display 12 and the amount of blur b on the approximate display surface, and is calculated, for example, at a ratio of P/(b·F) or more at which no difference occurs in the filmed video. Therefore, the rendering magnification can be made smaller than the rendering magnification based on the pixel interval P of the display 12 and the amount of blur b on the approximate display surface, and the amount of calculation for rendering can be further reduced.

### ⋅Example of Rendering With a Plurality of Computers

It is also possible to divide an area of the display 12 into a plurality of areas and render a reduced CG video displayed in each area with a different computer. In this case, the CG rendering unit 24 provided in one computer renders a reduced CG video corresponding to a CG video displayed in at least one of the plurality of areas obtained by dividing the display 12. This makes it possible to further reduce the amount of calculation for rendering per computer.

### ⋅Example of Lowering the Quality of the Outer Frustum and the Frame Rate

It is also possible to render only reduced CG videos corresponding to the inner frustum in real time at the rendering magnification r. In this case, the information processing device 13 renders reduced CG videos corresponding to the outer frustum at a rendering magnification lower than r, or lowers the frame rate of the outer frustum. This makes it possible to further reduce the amount of calculation for rendering.

### ⋅Computer

The series of processing steps described above can be executed by hardware or can also be executed by software. In a case where the series of processing steps is executed by software, a program included in the software is installed from a program storage medium on a computer incorporated in dedicated hardware, a general-purpose personal computer, or the like.

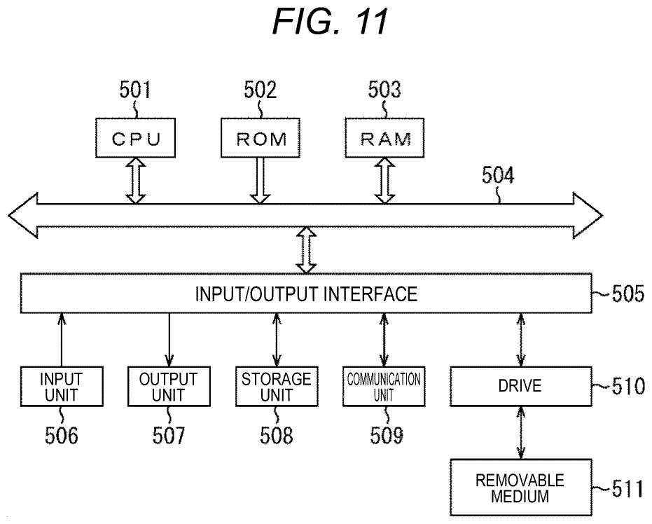

FIG. 11 is a block diagram illustrating an example of configuration of hardware of a computer that executes the above-described series of processing steps using a program.

A central processing unit (CPU) 501, a read only memory (ROM) 502, and a random access memory (RAM) 503 are connected to each other by a bus 504.

An input/output interface 505 is also connected to the bus 504. An input unit 506 including a keyboard, a mouse, and the like and an output unit 507 including a display, a speaker, and the like are connected to the input/output interface 505. Furthermore, a storage unit 508 including a hard disk, a nonvolatile memory, or the like, a communication unit 509 including a network interface or the like, and a drive 510 that drives a removable medium 511 are connected to the input/output interface 505.

In the computer configured as described above, for example, the CPU 501 loads a program stored in the storage unit 508 into the RAM 503 via the input/output interface 505 and the bus 504 and executes the program to execute the above-described series of processing steps.

For example, the program executed by the CPU 501 is stored in the removable medium 511, or provided via a wired or wireless transmission medium such as a local area network, the Internet, or digital broadcasting, and then installed in the storage unit 508.

The program executed by the computer may be a program in which the processing is performed in time series in the order described in the present description, or may be a program in which the processing is performed in parallel or at a necessary timing such as when a call is made.

Note that a system herein means an assembly of a plurality of components (devices, modules (parts), and the like), and it does not matter whether or not all the components are located in the same housing. Therefore, a plurality of devices housed in separate housings and connected to each other via a network and one device in which a plurality of modules is housed in one housing are both the systems.

The effects described in the present specification are merely examples and are not limited, and other effects may be provided.

Embodiments of the present technology are not limited to the embodiments described above, and various modifications can be made without departing from the scope of the present technology.

For example, the present technology may be embodied in cloud computing in which one function is shared and processed by a plurality of devices in cooperation via a network.

Furthermore, each step described in the flowcharts described above may be executed by a single device, or may be executed by a plurality of devices in a shared manner.

Moreover, in a case where a plurality of pieces of processing is included in one step, the plurality of pieces of processing included in the one step can be executed by one device or executed by a plurality of devices in a shared manner.

### ⋅Examples of Combinations of Components

The present technology can also have the following configurations.
(1)

An information processing device including:
a rendering unit that renders, on the basis of filming information regarding filming by a camera that films a display installed in a real space, a two-dimensional area within an angle of view of the camera indicating a predetermined three-dimensional space corresponding to the angle of view with reference to a display surface of the display; and
an image quality adjustment unit that reduces image quality of the area within the angle of view rendered by the rendering unit in a case where an amount of blur on the display surface in a filmed video filmed by the camera increases.
(2)

The information processing device according to (1), further including:
a display control unit that causes the display to display the area within the angle of view rendered by the rendering unit.
(3)

The information processing device according to (2), in which
the image quality adjustment unit lowers the image quality of the area within the angle of view by making a first resolution of the area within the angle of view rendered by the rendering unit lower than a second resolution of the display.
(4)

The information processing device according to (3), in which
the image quality adjustment unit calculates a rendering magnification indicating a ratio of the first resolution to the second resolution on the basis of a pixel interval of the display and the amount of blur on the display surface.
(5)

The information processing device according to (4), in which
the rendering magnification indicates a ratio equal to or higher than a value obtained by dividing the pixel interval of the display by the amount of blur on the display surface.
(6)

The information processing device according to (5), in which
the image quality adjustment unit calculates the rendering magnification by dividing the pixel interval of the display by the amount of blur on the display surface in a case where the pixel interval of the display is less than the amount of blur on the display surface.
(7)

The information processing device according to (5) or (6), in which
the image quality adjustment unit sets the rendering magnification to 1 in a case where the pixel interval of the display is equal to or more than the amount of blur on the display surface.
(8)

The information processing device according to any one of (4) to (7), in which
the display control unit increases a resolution of the area within the angle of view rendered by the rendering unit to a resolution equal to a resolution of the display.
(9)

The information processing device according to (8), in which
the display control unit increases, by super-resolution processing, the resolution of the area within the angle of view rendered by the rendering unit to a resolution equal to the resolution of the display.
(10)

The information processing device according to (9), in which
the image quality adjustment unit calculates the rendering magnification on the basis of a restoration magnification of the super-resolution processing along with the pixel interval of the display and the amount of blur on the display surface.
(11)

The information processing device according to (10), in which
the rendering magnification indicates a ratio equal to or higher than a value obtained by dividing the pixel interval of the display by the amount of blur on the display surface and dividing a resultant value by the restoration magnification of the super-resolution processing.
(12)

The information processing device according to any one of (1) to (11), in which
the image quality adjustment unit calculates the amount of blur on the display surface on the basis of the filming information.
(13)

The information processing device according to (12), in which
the image quality adjustment unit calculates, as the amount of blur on the display surface, an amount of blur on a plane including at least one point where an angle-of-view range of the camera and the display surface intersect and facing the camera.
(14)

The information processing device according to any one of (1) to (13), in which
the filming information includes information indicating a position of the camera and information indicating an internal state.
(15)

The information processing device according to (14), in which
the internal state includes the angle of view, a focus position, and an aperture value of the camera.
(16)

The information processing device according to any one of (1) to (15), in which
the rendering unit renders at least one of a plurality of areas obtained by dividing the area within the angle of view.
(17)

The information processing device according to any one of (1) to (15), in which
the rendering unit further renders a two-dimensional area outside the angle of view indicating the three-dimensional space corresponding to a periphery of the angle of view of the camera, and
the image quality adjustment unit reduces at least the image quality or a frame rate of the area outside the angle of view rendered by the rendering unit to be lower than the image quality or the frame rate of the area within the angle of view.
(18)

An information processing method including:
by an information processing device,
rendering, on the basis of filming information regarding filming by a camera that films a display installed in a real space, a two-dimensional area within an angle of view of the camera indicating a predetermined three-dimensional space corresponding to the angle of view with reference to a display surface of the display; and
reducing image quality of the area within the angle of view rendered in a case where an amount of blur on the display surface in a filmed video filmed by the camera increases.
(19)

A computer-readable storage medium storing a program for achieving a process of:
rendering, on the basis of filming information regarding filming by a camera that films a display installed in a real space, a two-dimensional area within an angle of view of the camera indicating a predetermined three-dimensional space corresponding to the angle of view with reference to a display surface of the display; and
reducing image quality of the area within the angle of view rendered in a case where an amount of blur on the display surface in a filmed video filmed by the camera increases.

### REFERENCE SIGNS LIST

1 Filming system
11 Camera
12 Display
13 Information processing device
14 Video storage device
21 Camera position estimation unit
22 Filming information obtaining unit
23 Rendering magnification calculation unit
24 CG rendering unit
25 3D model storage unit
26 Upscaling unit
61 Approximate display surface
101 Super-resolution processing unit

1. An information processing device comprising:
a rendering unit that renders, on a basis of filming information regarding filming by a camera that films a display installed in a real space, a two-dimensional area within an angle of view of the camera indicating a predetermined three-dimensional space corresponding to the angle of view with reference to a display surface of the display; and
an image quality adjustment unit that reduces image quality of the area within the angle of view rendered by the rendering unit in a case where an amount of blur on the display surface in a filmed video filmed by the camera increases.

2. The information processing device according to claim 1, further comprising:
a display control unit that causes the display to display the area within the angle of view rendered by the rendering unit.

3. The information processing device according to claim 2, wherein
the image quality adjustment unit lowers the image quality of the area within the angle of view by making a first resolution of the area within the angle of view rendered by the rendering unit lower than a second resolution of the display.

4. The information processing device according to claim 3, wherein
the image quality adjustment unit calculates a rendering magnification indicating a ratio of the first resolution to the second resolution on a basis of a pixel interval of the display and the amount of blur on the display surface.

5. The information processing device according to claim 4, wherein
the rendering magnification indicates a ratio equal to or higher than a value obtained by dividing the pixel interval of the display by the amount of blur on the display surface.

6. The information processing device according to claim 5, wherein
the image quality adjustment unit calculates the rendering magnification by dividing the pixel interval of the display by the amount of blur on the display surface in a case where the pixel interval of the display is less than the amount of blur on the display surface.

7. The information processing device according to claim 5, wherein
the image quality adjustment unit sets the rendering magnification to 1 in a case where the pixel interval of the display is equal to or more than the amount of blur on the display surface.

8. The information processing device according to claim 4, wherein
the display control unit increases a resolution of the area within the angle of view rendered by the rendering unit to a resolution equal to a resolution of the display.

9. The information processing device according to claim 8, wherein
the display control unit increases, by super-resolution processing, the resolution of the area within the angle of view rendered by the rendering unit to a resolution equal to the resolution of the display.

10. The information processing device according to claim 9, wherein
the image quality adjustment unit calculates the rendering magnification on a basis of a restoration magnification of the super-resolution processing along with the pixel interval of the display and the amount of blur on the display surface.

11. The information processing device according to claim 10, wherein
the rendering magnification indicates a ratio equal to or higher than a value obtained by dividing the pixel interval of the display by the amount of blur on the display surface and dividing a resultant value by the restoration magnification of the super-resolution processing.

12. The information processing device according to claim 1, wherein
the image quality adjustment unit calculates the amount of blur on the display surface on a basis of the filming information.

13. The information processing device according to claim 12, wherein
the image quality adjustment unit calculates, as the amount of blur on the display surface, an amount of blur on a plane including at least one point where an angle-of-view range of the camera and the display surface intersect and facing the camera.

14. The information processing device according to claim 1, wherein
the filming information includes information indicating a position of the camera and information indicating an internal state.

15. The information processing device according to claim 14, wherein
the internal state includes the angle of view, a focus position, and an aperture value of the camera.

16. The information processing device according to claim 1, wherein
the rendering unit renders at least one of a plurality of areas obtained by dividing the area within the angle of view.

17. The information processing device according to claim 1, wherein
the rendering unit further renders a two-dimensional area outside the angle of view indicating the three-dimensional space corresponding to a periphery of the angle of view of the camera, and
the image quality adjustment unit reduces at least the image quality or a frame rate of the area outside the angle of view rendered by the rendering unit to be lower than the image quality or the frame rate of the area within the angle of view.

18. An information processing method comprising:
by an information processing device,
rendering, on a basis of filming information regarding filming by a camera that films a display installed in a real space, a two-dimensional area within an angle of view of the camera indicating a predetermined three-dimensional space corresponding to the angle of view with reference to a display surface of the display; and
reducing image quality of the area within the angle of view rendered in a case where an amount of blur on the display surface in a filmed video filmed by the camera increases.

19. A computer-readable storage medium storing a program for achieving a process of:
rendering, on a basis of filming information regarding filming by a camera that films a display installed in a real space, a two-dimensional area within an angle of view of the camera indicating a predetermined three-dimensional space corresponding to the angle of view with reference to a display surface of the display; and
reducing image quality of the area within the angle of view rendered in a case where an amount of blur on the display surface in a filmed video filmed by the camera increases.
